(19) United States
(12) Patent Application Publication
(10) Pub. No.: US 2024/0101056 A1
(43) Pub. Date: Mar. 28, 2024

(54) POWER SUPPLY CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shunsuke YAMADA, Yokkaichi-shi, Mie (JP)

(21) Appl. No.: 18/257,392

(22) PCT Filed: Nov. 25, 2021
(86) PCT No.: PCT/JP2021/043152

§ 371 Date: Jun. 14, 2023

(30) Foreign Application Priority Data
Dec. 16, 2020 (JP) 2020-208206

(51) Int. Cl. B60R 16/03; H02J 7/00

(52) U.S. Cl. CPC B60R 16/03; H02J 7/0013; H02J 7/00712; H02J 2207/20

(57) ABSTRACT

Provided is a power supply control device that can favorably supply power to a plurality of electric loads. The power supply control device controls discharge from a power supply unit including a plurality of power storage units. The power supply control device includes a switch unit that changes the connection states of the plurality of power storage units and a control unit that controls the switch unit. The switch unit switches between a first connection state in which charging current can be supplied to all of the plurality of power storage units and a second connection state in which the plurality of power storage units are divided into a plurality of power storage unit regions. When the switch unit 30 is in the second connection state, power is supplied from the plurality of power storage unit regions to the corresponding target loads.

### CROSS-REFERENCE TO RELATED APPLICATIONS

This application is the U.S. national stage of PCT/JP2021/043152 filed on Nov. 25, 2021, which claims priority of Japanese Patent Application No. JP 2020-208206 filed on Dec. 16, 2020, the contents of which are incorporated herein.

### TECHNICAL FIELD

The present disclosure relates to a power supply control device.

### BACKGROUND

As a result of the vehicle power supply device disclosed in JP 2020-150763A using a switch control unit to control a switch unit, a plurality of battery units can be charged by a charger or power can be supplied to a motor from one battery unit while another battery unit serves as a backup.

In a configuration where, for example, power is backed up for a plurality of electric loads and the plurality of electric loads include an electric load whose power consumption is undetermined, there is a concern that the electric load whose power consumption is undetermined may consume power required by the other electric loads, depending on the magnitude of the power consumption of the electric load whose power consumption is undetermined.

The present disclosure was made in view of the circumstances described above. An object of the present disclosure is to provide a power supply control device that can favorably supply power to a plurality of electric loads.

### SUMMARY

A power supply control device of the present disclosure is a power supply control device that controls discharge from a power supply unit. The power supply unit includes a plurality of power storage units. The power supply control device includes a switch unit that switches connection states of the plurality of power storage units, and a control unit that controls the switch unit. The switch unit switches between a first connection state in which charging current can be supplied to all of the plurality of power storage units and a second connection state in which the plurality of power storage units are divided into a plurality of power storage unit regions, and when the switch unit is in the second connection state, power is supplied from the plurality of power storage unit regions to corresponding target loads.

### Advantageous Effects

The power supply control device of the present disclosure can favorably supply power to a plurality of electric loads.

### BRIEF DESCRIPTION OF DRAWINGS

FIG. 1 is a block diagram schematically illustrating an in-vehicle power supply system including a power supply control device in a first embodiment, which shows a state in which a switch unit is switched to a first connection state.

FIG. 2 is a block diagram schematically illustrating the in-vehicle power supply system including the power supply control device in the first embodiment, which shows a state in which the switch unit is switched to a second connection state.

FIG. 3 is a flowchart illustrating a flow of a switch control executed by a control unit in the first embodiment.

FIG. 4 is a block diagram schematically illustrating an in-vehicle power supply system including a power supply control device in a second embodiment, which shows a state in which a switch unit is switched to a first connection state.

FIG. 5 is a block diagram schematically illustrating the in-vehicle power supply system including the power supply control device in the second embodiment, which shows a state in which the switch unit is switched to a second connection state.

### DETAILED DESCRIPTION OF PREFERRED EMBODIMENTS

First, embodiments of the present disclosure will be listed and described.

(1) A power supply control device is a power supply control device that controls discharge from a power supply unit including a plurality of power storage units. The power supply control device includes: a switch unit that switches connection states of the plurality of power storage units; and a control unit that controls the switch unit. The switch unit switches between a first connection state in which charging current can be supplied to all the plurality of power storage units and a second connection state in which the plurality of power storage units are divided into a plurality of power storage unit regions. When the switch unit is in the second connection state, power is supplied from the plurality of power storage unit regions to corresponding target loads.

If it is preferred that one of the plurality of target loads be isolated, the power supply control device according to (1) can isolate one of the target loads while individually supplying power from the storage units to the isolated target load and the target loads other than the isolated target load.

(2) The power supply control device according to (1) may include a charging circuit. The control unit may switch the switch unit to the first connection state in the charging current is supplied from the charging circuit to the power supply unit, and may switch the switch unit to the second connection state when power is discharged from the power supply unit.

The power supply control device according to (2) can switch the switch unit to the first connection state to collectively charge the power storage unit regions that individually supply power to one of the target loads and the target loads other than the one the target load.

(3) The power supply control device according to (1) or (2) includes a voltage conversion unit. If a predetermined discharge condition is satisfied, the control unit causes the voltage conversion unit to operate with the switch unit switched to the second connection state. When the voltage conversion unit operates in the second connection state in response to the satisfaction of the discharge condition, the voltage conversion unit performs voltage conversion based on power from one of the plurality of divided power storage unit regions and supplies the resultant power to one of the target loads. In addition, another power storage unit region and another target load may become conductive, without involving the voltage conversion unit, to supply the power to the other target load.

The power supply control device according to (3) can supply power subjected to voltage conversion by the voltage conversion unit to a target load to which power subjected to voltage conversion by the voltage conversion unit is preferably to be supplied. The power supply control device according to (3) can also supply power, without involving the voltage conversion unit, to a target load to which power is preferably to be supplied without involving the voltage conversion unit.

(4) The power supply control device according to (3) includes a first switch, a second switch, a third switch, and a fourth switch. The first switch switches a main power supply unit, the power supply unit, and the plurality of target loads, between a connected state and a disconnected state. The second switch switches the power storage unit regions between the connected state and the disconnected state. The third switch switches the other power storage unit region and the other target load between the connected state and the disconnected state. The fourth switch switches the other target load and the main power supply unit between the connected state and the disconnected state. When switching the switch unit from the first connection state to the second connection state, the control unit executes a first control, a second control, and a third control in this order. In the first control, the control unit uses the first switch to switch the main power supply unit, the power supply unit, and the plurality of target loads, from the connected state to the disconnected state. In the second control, the control unit uses the second switch to switch the power storage unit regions from the connected state to the disconnected state. In the third control, the control unit uses the fourth switch to switch the other target load and the main power supply unit from the connected state to the disconnected state. Then, the control unit may execute a fourth control to use the third switch to switch the other the power storage unit region and the other target load from the disconnected state to the connected state or execute a discharge control to discharge power from the voltage conversion unit.

The power supply control device according to (4) executes the first control, the second control, and the third control in this order. After that, the power supply control device according to (4) can execute the fourth control or the discharge control to smoothly switch from the first connection state to the second connection state while suppressing a burden on constituent elements.

(5) In the power supply control device according to any one of (1) to (4), in the first connection state, the switch unit maintains a state in which the plurality of power storage units are connected in series. In the second connection state, the switch unit may divide the plurality of power storage units connected in series into the plurality of power storage unit regions.

In the power supply control device according to (5), the plurality of power storage units are connected in series. Thus, increasing or decreasing the number of power storage units makes it easy to change the output voltage to a desired magnitude.

(6) In the power supply control device according to any one of (1) to (4), in the first connection state, the switch unit maintains a state in which the plurality of power storage units are connected in parallel. In the second connection state, the switch unit may divide the plurality of power storage units connected in parallel into the plurality of power storage unit regions.

In the power supply control device according to (6), the plurality of power storage units are connected in parallel. Thus, it is easy to keep the output voltage from the power supply unit at a predetermined magnitude for a longer period of time than in the case where the power storage units are connected in series.

### First Embodiment

Hereinafter, a first embodiment in which the present disclosure is embodied will be described.

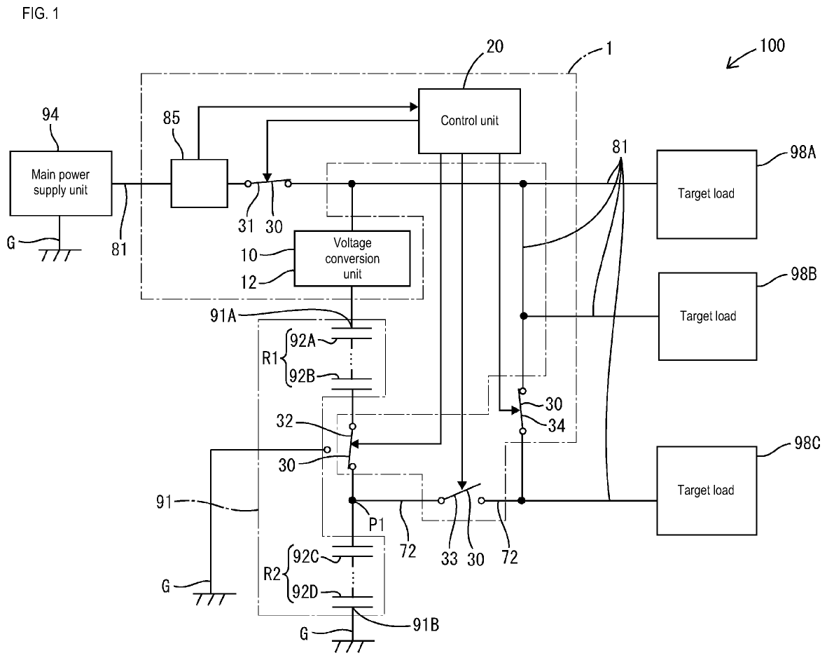

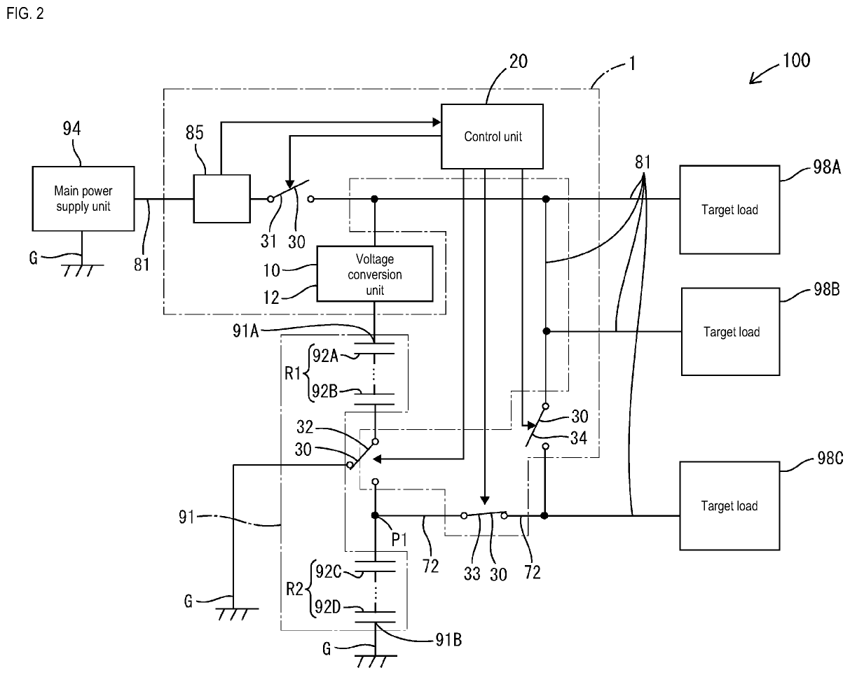

An in-vehicle power supply system 100 (hereinafter, also called a “power supply system 100”) shown in FIGS. 1 and 2 is configured as a system that is capable of supplying power from a main power supply unit 94 to a voltage conversion unit 10 via a first conductive path 81 to charge a power supply unit 91, supplying power from the main power supply unit 94 to a plurality of target loads 98A, 98B, and 98C via the first conductive path 81, converting a voltage applied from the power supply unit 91 by using the voltage conversion unit 10, and supplying the converted voltage to the plurality of target loads 98A, 98B, and 98C via the first conductive path 81.

The plurality of target loads 98A, 98B, and 98C are in-vehicle electric devices mounted in a vehicle and are electrically connected to the first conductive path 81, and can operate with power supplied via the first conductive path 81. The type and number of the plurality of target loads 98A, 98B, and 98C are not limited. The target loads 98A and 98B are examples of one target load. The power consumptions of the target loads 98A and 98B do not largely change depending on the usage situation, and are kept at a generally stable level. The target load 98C is an example of another target load. The power consumption of the target load 98C has a characteristic of varying depending on the usage situation, and is undetermined.

In the present disclosure, the “electrically connected” configuration is desirably a configuration in which connection targets are connected in a conductive state (in which current is flowable) such that the potentials of the connection targets are equal. However, the present disclosure is not limited to this configuration. For example, the “electrically connected” configuration may be a configuration in which connection targets are connected in a conductible state with an electrical component interposed therebetween.

### Outline of Power Supply System

The power supply system 100 mainly includes the main power supply unit 94, the first conductive path 81, the power supply unit 91, a bypass conductive path 72, a power supply control device 1, and the like.

The main power supply unit 94 is a main power source for supplying power to the plurality of target loads 98A, 98B, and 98C, and the power supply unit 91, and is configured as an in-vehicle battery such as a lead battery, for example. The main power supply unit 94 has a high-potential terminal that is electrically connected to the first conductive path 81 and has a low-potential terminal that is electrically connected to a reference conductive path G kept at a ground potential (0 V). The main power supply unit 94 applies a predetermined output voltage to the first conductive path 81.

The main power supply unit 94, the voltage conversion unit 10 of the power supply control device 1, the plurality of target loads 98A, 98B, and 98C, and the like are electrically connected to the first conductive path 81.

The power supply unit 91 has a configuration in which a plurality of power storage units 92A, 92B, 92C, and 92D are connected in series. Each of the power storage units 92A, 92B, 92C, and 92D is formed by an in-vehicle power storage means such as a lead battery, an electric-double-layer capacitor, or a lithium-ion battery, and is electrically connected to the voltage conversion unit 10. A highest-potential terminal 91A of the power supply unit 91 is electrically connected to the voltage conversion unit 10. A lowest-potential terminal 91B of the power supply unit 91 is electrically connected to the reference conductive path G kept at the ground potential (0 V), for example. In the examples shown in FIGS. 1 and 2, the power supply unit 91 is formed by connecting the four power storage units 92A, 92B, 92C, and 92D in series. The voltage conversion unit 10 is interposed between the power supply unit 91 and the first conductive path 81.

The bypass conductive path 72 is a path for supplying power from a first position P1 between the power storage units in the power supply unit 91 to the portion of the first conductive path 81 electrically connected to the target load 98C. Specifically, one end of the bypass conductive path 72 is electrically connected to the first position P1. The other end of the bypass conductive path 72 is electrically connected to the first conductive path 81 that is electrically connected to the target load 98C. The first position P1 is a position where a low-potential terminal of the power storage unit 92B located closer to the high-potential side than the first position P1 is electrically connected to a high-potential terminal of the power storage unit 92C located closer to the low-potential side than the first position P1.

The power supply control device 1 mainly includes a switch unit 30, a control unit 20, the voltage conversion unit 10, and the like. The switch unit 30 has a first switch 31, a second switch 32, a third switch 33, and a fourth switch 34. The first switch 31, the second switch 32, the third switch 33, and the fourth switch 34 are each formed using one or more semiconductor switches such as MOSFETs or bipolar transistors, or mechanical relays, for example.

The first switch 31 is provided between the main power supply unit 94 on the first conductive path 81, the voltage conversion unit 10, and the plurality of target loads 98A, 98B, and 98C. The first switch 31 is provided at an intermediate position of the first conductive path 81. When on, the first switch 31 enables continuity between the main power supply unit 94, the voltage conversion unit 10, the power supply unit 91 electrically connected to the voltage conversion unit 10, and the plurality of target loads 98A, 98B, and 98C. When off, the first switch 31 shuts off the continuity between the main power supply unit 94, the voltage conversion unit 10, the power supply unit 91 electrically connected to the voltage conversion unit 10, and the plurality of target loads 98A, 98B, and 98C. That is, the first switch 31 switches the connection state between the connected state in which continuity is enabled between the main power supply unit 94, the voltage conversion unit 10, the power supply unit 91 electrically connected to the voltage conversion unit 10, and the plurality of target loads 98A, 98B, and 98C, and the disconnected state in which the continuity is shut off.

The second switch 32 is provided between, out of the plurality of power storage units 92A, 92B, 92C, and 92D, the power storage units 92A and 92B in a power storage unit region R1 and the power storage units 92C and 92D in a power storage unit region R2. The power storage unit region R1 is an example of any one of the power storage unit regions. The power storage unit region R2 is an example of any other of the power storage unit regions. The second switch 32 is interposed between the low-potential terminal of the power storage unit 92B and the high-potential terminal of the power storage unit 92C.

When on, the second switch 32 is conductive to enable bidirectional power distribution. When off, the second switch 32 is non-conductive to disable bidirectional power distribution. That is, the second switch 32 of the switch unit 30 switches the connection states of the plurality of power storage units 92A, 92B, 92C, and 92D. The second switch 32 is connected in series with the plurality of power storage units 92A, 92B, 92C, and 92D, and is disposed between the power storage units in the power supply unit 91.

When on, the second switch 32 switches an inter-power storage unit path between the power storage units 92C and 92D (the power storage unit region R2) that are positioned closer to the low-potential side than the second switch 32 and the power storage units 92A and 92B (the power storage unit region R1) that are positioned closer to the high-potential side than the second switch 32, to the conductive state. When off, the second switch 32 switches the inter-power storage unit path to the non-conductive state and electrically connects the low-potential terminal of the power storage unit 92B to the reference conductive path G kept at the ground potential (0 V) (see FIG. 2). Specifically, the second switch 32 is provided between, out of the power storage units 92C and 92D located at the low-potential side in the power supply unit 91, the power storage unit 92C that is located the high-potential side and, out of the power storage units 92A and 92B, the power storage unit 92B that is located on the low-potential side. When on, the second switch 32 enables continuity between the power storage unit 92C and the power storage unit 92B so that current can flow therebetween. When off, the second switch 32 shuts off the continuity between the power storage unit 92C and the power storage unit 92B so that no current flows therebetween. That is, the second switch 32 switches the connection state between the connected state in which continuity is enabled between the power storage unit region R1 and R2, and the disconnected state in which the continuity between the power storage unit regions R1 and R2 is shut off.

The third switch 33 is provided on the bypass conductive path 72. The third switch 33 is provided at an intermediate position of the bypass conductive path 72. When on, the third switch 33 provides continuity between the first position P1 and the target load 98C to enable power supply from the first position P1 to the first conductive path 81 electrically connected to the target load 98C. When off, the third switch 33 shuts off the continuity between the first position P1 and the target load 98C to shut off the power supply from the first position P1 to the first conductive path 81 electrically connected to the target load 98C. That is, the third switch 33 switches the connection state between the connected state in which continuity is enabled between the power storage unit region R2 and the target load 98C and the disconnected state in which the continuity between the power storage unit region R2 and the target load 98C is shut off.

The fourth switch 34 is provided between one target load 98C, out of the plurality of target loads 98A, 98B, and 98C on the first conductive path 81, and the main power supply unit 94. The fourth switch 34 is provided at an intermediate position of the first conductive path 81. When on, the fourth switch 34 enables continuity between the target load 98C and the main power supply unit 94 together with the plurality of target loads 98A and 98B. When off, the fourth switch 34 shuts off the continuity between the target load 98C and the main power supply unit 94. That is, the fourth switch 34 switches the connection state between the connected state in which to enable continuity is enabled between the target load 98C and the main power supply unit 94, and the disconnected state in which the continuity between the target load 98C and the main power supply unit 94 is shut off.

The control unit 20 is an in-vehicle electronic control device that can control the switches in the switch unit 30 (the first switch 31, the second switch 32, the third switch 33, and the fourth switch 34) and includes various devices such as an information processing device such as a CPU, a storage device, and an AD converter. The control unit 20 accepts input of a voltage value of the first conductive path 81 detected by a voltage detection unit 85. Accordingly, the control unit 20 can grasp the voltage value of the first conductive path 81. The control unit 20 may be constituted by a single electronic control device or may be constituted by a plurality of electronic control devices. The control performed by the control unit 20 will be described later.

The voltage conversion unit 10 is provided interposed between the first conductive path 81 and the power supply unit 91. The voltage conversion unit 10 is a circuit that can perform a step-up operation in which the voltage applied to the first conductive path 81 is increased and apply the increased voltage to the power supply unit 91 and can decrease the voltage applied from the power supply unit 91 and apply the decreased voltage to the first conductive path 81. The voltage conversion unit 10 can be configured as a bidirectional DC/DC converter that includes a semiconductor switching element, an inductor, and the like. Specifically, the voltage conversion unit 10 can preferably be a synchronous rectification-type non-isolated DC/DC converter or a diode-type non-isolated DC/DC converter.

For example, in the case of forming the voltage conversion unit 10 as a synchronous rectification-type non-insulated DC/DC converter, the voltage conversion unit 10 can be controlled by the control unit 20. The control unit 20 provides a step-up control signal (PWM signal) to the voltage conversion unit 10, and the control signal (PWM signal) is subjected to feedback control so that the voltage applied to the first conductive path 81 is increased and the desired target voltage is applied to the power supply unit 91. The duty of the control signal (PWM signal) is adjusted by a feedback computational operation. In this manner, the power supply unit 91 is charged. That is, the voltage conversion unit 10 functions as a charging circuit 12 that charges the power supply unit 91. The control unit 20 also provides a step-down control signal (PWM signal) to the voltage conversion unit 10, and the control signal (PWM signal) is subjected to feedback control so that the voltage applied from the power supply unit 91 is decreased and the desired target voltage is applied to the first conductive path 81.

### Control by Control Unit

Next, control by the control unit 20 will be described.

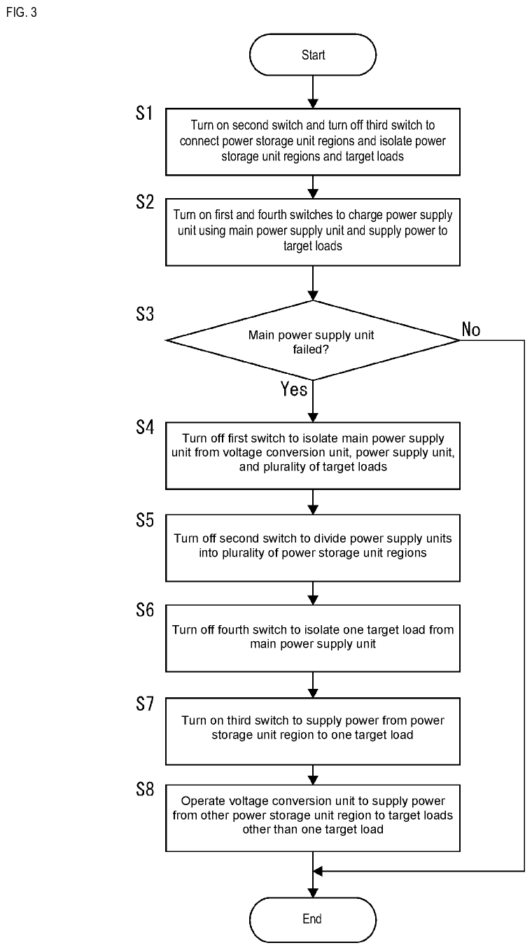

The control unit 20 executes the control shown in FIG. 3 in response to the satisfaction of a predetermined start condition. Specifically, the control unit 20 executes the control shown in FIG. 3 if the vehicle equipped with the power supply control device 1 is brought into a start-up state (for example, a start switch such as the ignition switch switches from the off state to the on state).

When the control shown in FIG. 3 is started, the control unit 20 first performs step S1 to turn the third switch 33 off and turn the second switch 32 on. When the third switch 33 is turned off, the power supply from the first position P1 to the first conductive path 81 electrically connected to the target load 98C is shut off. When the second switch 32 is turned on, the inter-power storage unit path between the low-potential power storage units 92C and 92D positioned closer to the low-potential side than the second switch 32 and the high-potential power storage units 92A and 92B positioned closer to the high-potential side than the second switch 32 is switched to the conductive state. Accordingly, these power storage units 92A, 92B, 92C, and 92D are connected in series. At this time, the low-potential terminal of the power storage unit 92B is not electrically connected to the reference conductive path G kept at the ground potential (0 V).

Next, when the process proceeds to step S2, the control unit 20 turns the first switch 31 and the fourth switch 34 on. When the first switch 31 is turned on, the continuity between the main power supply unit 94 and the voltage conversion unit 10, and the plurality of loads 98A, 98B, and 98C is enabled. When the fourth switch 34 is turned on, the continuity between the target load 98C and the main power supply unit 94 is enabled together with the plurality of target loads 98A and 98B. Then, the control unit 20 provides a step-up control signal (PWM signal) to the voltage conversion unit 10 and outputs the control signal to the voltage conversion unit 10 so as to increase the voltage applied to the first conductive path 81 and apply the desired target voltage to the power supply unit 91 to cause the voltage conversion unit 10 to operate as the charging circuit 12. Accordingly, the switch unit 30 switches to the first connection state in which the charging current from the main power supply unit 94 supplied via the voltage conversion unit 10 can be supplied to all of the plurality of power storage units 92A, 92B, 92C, and 92D (see FIG. 1). The case where the charging current can be supplied to all of the plurality of power storage units 92A, 92B, 92C, and 92D means that the charging current can flow from the terminal 91A located on the highest-potential side to the power storage unit 92A and can flow from the power supply unit 91B located on the lowest-potential side to the reference conductive path G. At this time, the voltage conversion unit 10 operates as the charging circuit 12. That is, in the case where a charging current is supplied from the charging circuit 12 to the power supply unit 91, the control unit 20 switches the switch unit 30 to the first connection state. In the first connection state, the switch unit 30 maintains the state in which the plurality of power storage units 92A, 92B, 92C, and 92D are connected in series.

Next, when the process proceeds to step S3, the control unit 20 determines whether the main power supply unit 94 has failed. For example, the control unit 20 determines whether or not the main power supply unit 94 has failed based on the voltage value of the first conductive path 81 detected by the voltage detection unit 85. If the control unit 20 determines in step S3 that the main power supply unit 94 has not failed (No in step S3), the process shown in FIG. 3 is ended.

If the control unit 20 determines in step S3 that the main power supply unit 94 has failed (Yes in step S3), the control unit 20 proceeds to step S4 to switch the switch unit 30 from the first connection state to the second connection state. When the process proceeds to step S4, the control unit 20 executes a first control. Specifically, the control unit 20 turns the first switch 31 off from being on. When the first switch 31 is turned off, the continuity between the main power supply unit 94, the voltage conversion unit 10, the power supply unit 91 electrically connected to the voltage conversion unit 10, and the plurality of target loads 98A, 98B, and 98C is shut off. That is, in the first control, the first switch 31 is turned off to switch the main power supply unit 94, the voltage conversion unit 10, the power supply unit 91 electrically connected to the voltage conversion unit 10, and the plurality of target loads 98A, 98B, and 98C, from the connected state to the disconnected state. Accordingly, the main power supply unit 94 is disconnected from the voltage conversion unit 10, the power supply unit 91 electrically connected to the voltage conversion unit 10, and the plurality of target loads 98A, 98B, and 98C.

Next, when the process proceeds to step S5, the control unit 20 executes a second control. Specifically, the control unit 20 turns the second switch 32 from the on state to the off state. When the second switch 32 is turned to the off state, the power storage units 92A and 92B connected in series and the power storage units 92C and 92D connected in series are divided into two power storage unit regions R1 and R2. Along with this, the low-potential terminal of the power storage unit 92B is electrically connected to the reference conductive path G kept at the ground potential (0 V). That is, in the second control, the second switch 32 is turned off to switch the power storage unit regions R1 and R2 from the connected state to the disconnected state.

Next, when the process proceeds to step S6, the control unit 20 executes a third control. Specifically, the control unit 20 turns the fourth switch 34 off from being on. When the fourth switch 34 is turned off, the continuity between the target load 98C and the main power supply unit 94 is shut off. That is, in the third control, the fourth switch 34 is turned off to switch the target load 98C and the main power supply unit 94 from the connected state to the disconnected state. Accordingly, the target load 98C and the main power supply unit 94 are disconnected from each other.

Next, when the process proceeds to step S7, the control unit 20 executes a fourth control. Specifically, the control unit 20 turns the third switch 33 on. When the third switch 33 is turned on, power supply from the first position P1 to the portion of the first conductive path 81 electrically connected to the target load 98C. That is, in the fourth control, the third switch 33 is turned on to switch the power storage unit region R2 and the target load 98C from the disconnected state to the connected state. Accordingly, the switch unit 30 switches to the second connection state in which the plurality of power storage units 92A, 92B, 92C, and 92D are divided into the plurality of power storage unit regions R1 and R2 (see FIG. 2). In the second connection state, the switch unit 30 divides the plurality of power storage units 92A, 92B, 92C, and 92D connected in series into the plurality of power storage unit regions R1 and R2. At this time, power supply from the power storage unit region R2 to the target load 98C is started.

Next, when the process proceeds to step S8, the control unit 20 executes discharge control. Specifically, the control unit 20 causes the voltage conversion unit 10 operating as the charging circuit 12 to perform a discharge operation of supplying power from the power storage unit region R1 of the power supply unit 91 to the target loads 98A and 98B. That is, if a predetermined discharge condition (that is, the failure of the main power supply unit 94) is satisfied, the control unit 20 switches the switch unit 30 to the second connection state and causes the voltage conversion unit 10 to perform a discharge operation. When the discharge operation of the voltage conversion unit 10 is started, the voltage applied from the power storage unit region R1 of the power supply unit 91 is decreased at the voltage conversion unit 10 and the desired target voltage is applied to the first conductive path 81. If the difference in potential between the high-potential terminal and low-potential terminal of the power storage unit region R1 is smaller than the voltage necessary for operating the target loads 98A and 98B, the control unit 20 may increase the voltage using the voltage conversion unit 10 and apply the desired target voltage to the first conductive path 81.

Accordingly, power supply from the power storage unit region R1 to the target loads 98A and 98B is started. That is, the control unit 20 switches the switch unit 30 to the second connection state in the case of supplying the power discharged from the power storage unit region R1 of the power supply unit 91 to the target loads 98A and 98B. Accordingly, the power is supplied from the power supply unit 91 to the target loads 98A and 98B other than the target load 98C, and the process shown in FIG. 3 is ended. When the switch unit 30 is in the second connection state, the power supply control device 1 supplies power from the power storage unit regions R1 and R2 to the corresponding target loads 98A, 98B, and 98C. Switching the switch unit 30 to the second connection state prevents a change in the power consumption of the target load 98C from affecting the magnitude of the power to be supplied to the target loads 98A and 98B.

That is, when the voltage conversion unit 10 performs a discharge operation in the second connection state in response to the satisfaction of the discharge condition, the power from one power storage unit region R1 out of the plurality of divided power storage unit regions R1 and R2 is subjected to voltage conversion by the voltage conversion unit 10 and then is supplied to the target loads 98A and 98B. Then, the power storage unit region R2 and the target load 98C become conductive, without involving the voltage conversion unit 10, to supply power to the target load 98C.

Next, effects of the present configuration will be exemplified.

The power supply control device 1 controls discharge from the power supply unit 91 including the plurality of power storage units 92A, 92B, 92C, and 92D. The power supply control device 1 includes the switch unit 30 that changes the connection states of the plurality of power storage units 92A, 92B, 92C, and 92D, and the control unit 20 that controls the switch unit 30. The switch unit 30 switches between the first connection state in which discharging current can be supplied to all of the plurality of power storage units 92A, 92B, 92C, and 92D and the second connection state in which the plurality of power storage units 92A, 92B, 92C, and 92D are divided into the plurality of power storage unit regions R1 and R2. When the switch unit 30 is in the second connection state, power is supplied from the power storage unit regions R1 and R2 to the target loads 98A, 98B, and 98C.

According to this configuration, if it is preferrable that one target load 98C out of the plurality of target loads 98A, 98B, and 98C be isolated, the one target load 98C is to be isolated. Along with this, the power from the power storage unit regions R1 and R2 can be individually supplied to the one target load 98C and the target loads 98A and 98B other than the one target load 98C.

The power supply control device 1 includes the charging circuit 12. The control unit 20 switches the switch unit 30 to the first connection state when charging current is supplied from the charging circuit 12 to the power supply unit 91, and switches the switch unit 30 to the second connection state when power is discharged from the power supply unit 91. According to this configuration, the power supply control device 1 can switch the switch unit 30 to the first connection state to collectively charge the power storage unit regions R1 and R2 that individually supply power to the one target load 98C and the target loads 98A and 98B other than the one target load 98C.

The power supply control device 1 includes the voltage conversion unit 10. If a predetermined discharge condition is satisfied, the control unit 20 causes the voltage conversion unit 10 to operate with the switch unit 30 switched to the second connection state. When the voltage conversion unit 10 operates in the second connection state in response to the satisfaction of the discharge condition, the power from one power storage unit region R1 out of the plurality of divided power storage unit regions R1 and R2 is subjected to voltage conversion by the voltage conversion unit 10 and is supplied to one of the target loads 98A and 98B. In addition, the power storage unit region R2 and the target load 98C become conductive, without involving the voltage conversion unit 10, to supply the power to the target load 98C.

According to this configuration, the power supply control device 1 can supply power subjected to voltage conversion by the voltage conversion unit 10 to the target loads 98A and 98B to which power subjected to voltage conversion by the voltage conversion unit 10 is preferably to be supplied. The power supply control device 1 can also supply power to the target load 98C, without involving the voltage conversion unit 10, to the target load 98C to which power is preferably to be supplied to without involving the voltage conversion unit 10.

The switch unit 30 of the power supply control device 1 includes the first switch 31, the second switch 32, the third switch 33, and the fourth switch 34. The first switch 31 switches the main power supply unit 94, the power supply unit 91, and the plurality of target loads 98A, 98B, and 98C between the connected state and the disconnected state. The second switch 32 switches the power storage unit regions R1 and R2 between the connected state and the disconnected state. The third switch 33 switches the power storage unit region R2 and the target load 98C between the connected state and the disconnected state. The fourth switch 34 switches the target load 98C and the main power supply unit 94 between the connected state and the disconnected state. When switching the switch unit 30 from the first connection state to the second connection state, the control unit 20 executes the first control, the second control, and the third control in this order. In the first control, the control unit 20 uses the first switch 31 to switch the main power supply unit 94, the power supply unit 91, and the plurality of target loads 98A, 98B, and 98C from the connected state to the disconnected state. In the second control, the control unit 20 uses the second switch 32 to switch the power storage unit regions R1 and R2 from the connected state to the disconnected state. In the third control, the control unit 20 uses the fourth switch 34 to switch the target load 98C and the main power supply unit 94 from the connected state to the disconnected state. Then, the control unit 20 executes the fourth control to use the third switch 33 to switch the power storage unit region R2 and the target load 98C from the disconnected state to the connected state.

According to this configuration, the power supply control device 1 executes the first control, the second control, and the third control in this order. After that, the power supply control device 1 can execute the fourth control to smoothly switch from the first connection state to the second connection state while suppressing a burden on constituent elements.

In the power supply control device 1, in the first connection state, the switch unit 30 maintains the state in which the plurality of power storage units 92A, 92B, 92C, and 92D are connected in series. In the second connection state, the switch unit 30 divides the plurality of power storage units 92A, 92B, 92C, and 92D connected in series into the plurality of power storage unit regions R1 and R2. According to this configuration, in the power supply control device 1, the plurality of power storage units 92A, 92B, 92C, and 92D are connected in series. Thus, increasing or decreasing the number of power storage units makes it easy to change the output voltage to a desired magnitude.

### Second Embodiment

An in-vehicle power supply system 200 including a power supply control device 2 according to a second embodiment of the present disclosure will be described with reference to FIGS. 3 to 5. The power supply control device 2 according to the second embodiment is different from the first embodiment in the parallel connection of a power supply unit 191, the position where one end of a bypass conductive path 172 is electrically connected, and the position where a second switch 132 of a switch unit 130 is provided. The same components as those of the first embodiment will be denoted with identical reference signs, and description of structures, operations, and advantageous effects thereof will be omitted.

The power supply unit 191 has a configuration in which power storage units 92A and 92B connected in series in a power storage unit region R11 and power storage units 92C and 92D connected in series in a power storage unit region R12 are connected in parallel. The power storage unit region R11 is an example of one of the power storage unit regions. The power storage unit region R12 is an example of another of the power storage unit regions. That is, the plurality of power storage units 92A, 92B, 92C, and 92D are connected in parallel. High-potential terminals 191A of the power storage unit 92A and power storage unit 92C are electrically connected to a voltage conversion unit 10. Low-potential terminals 191B of the power storage unit 92B and power storage unit 92D are electrically connected to the storage conductive path G kept at a ground potential (0 V).

One end of the bypass conductive path 172 is electrically connected to a first position P11. The first position P11 is a position where high-potential terminals of the power storage unit regions R11 and R12 (that is, the high-potential terminals of the power storage units 92A and 92C) and the voltage conversion unit 10 are electrically connected.

The second switch 132 of the switch unit 130 is provided between the voltage conversion unit 10 and the power storage unit region R12 (the power storage units 92C and 92D). Specifically, the second switch 132 is interposed between the voltage conversion unit 10 and the high-potential terminal of the power storage unit 92C. The second switch 132 is not interposed between the voltage conversion unit 10 and the power storage unit region R11 (the power storage units 92A and 92B). That is, the voltage conversion unit 10 and the power storage unit region R11 are conductive at any time regardless of the state of the second switch 132.

The second switch 132 is configured in a manner similar to the second switch 32. When on, the second switch 132 is conductive to enable bidirectional power distribution. When off, the second switch 132 is non-conductive to disable bidirectional power distribution. The second switch 132 is connected in series with the power storage units 92C and 92D and is connected in parallel to the power storage units 92A and 92B in the power supply unit 191.

When on, the second switch 132 switches the path between the voltage conversion unit 10 and the power storage units 92C and 92D (the power storage unit region R12) to the conductive state. When off, the second switch 132 switches this path to the non-conductive state. When the second switch 132 is on, the power storage unit 92C and the voltage conversion unit 10 are conductive so that current can flow therebetween. When the second switch 132 is off, the power storage unit 92C and the voltage conversion unit 10 are electrically disconnected so that no current flows therebetween.

### Control by Control Unit

Next, control performed by the control unit 20 in the second embodiment will be described. As in the first embodiment, the control unit 20 executes the control shown in FIG. 3 in response to the satisfaction of a predetermined start condition. Hereinafter, description of the same parts of the control performed by the control unit 20 as those of the first embodiment will be omitted.

When the control shown in FIG. 3 is started, first, the control unit 20 performs step S1 to turn the third switch 33 off and turn the second switch 132 on. The second switch 132 is turned on to switch the path between the voltage conversion unit 10 and the power storage unit 92C to the conductive state. Accordingly, the power storage unit 92A and 92B in the power storage unit region R11 and the power storage unit 92C and 92D in the power storage unit region R12 are connected in parallel.

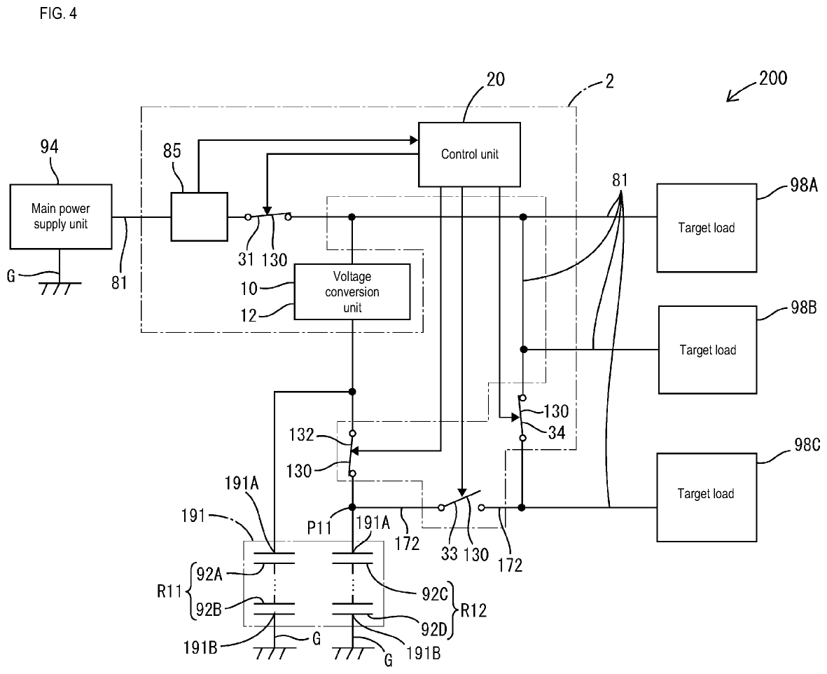

Next, when the process proceeds to step S2, the control unit 20 turns the first switch 31 and the fourth switch 34 on. At this time, as illustrated in FIG. 4, the switch unit 130 switches to the first connection state in which charging current supplied from the main power supply unit 94 via the voltage conversion unit 10 can be supplied to all of the plurality of power storage units 92A, 92B, 92C, and 92D. The state in which the charging current can be supplied to all of the plurality of power storage units 92A, 92B, 92C, and 92D means the state in which the charging current can flow from the terminal 191A located at the highest potential to the power storage units 92A and 92C and can flow from the terminal 191B located at the lowest potential to the reference conductive path G. In the first connection state, the switch unit 130 maintains the state in which the plurality of power storage units 92A and 92B and 92C and 92D are connected in parallel.

Next, when the process proceeds to step S3, the control unit 20 determines whether or not the main power supply unit 94 has failed. If the control unit 20 determines that the main power supply unit 94 has not failed (No in step S3), the process shown in FIG. 3 is ended.

If the control unit 20 determines in step S3 that the main power supply unit 94 has failed (Yes in step S3), the process proceeds to step S4. When the process proceeds to step S4, the control unit 20 executes the first control.

Next, when the process proceeds to step S5, the control unit 20 executes the second control. Specifically, the control unit 20 turns the second switch 132 off. When the second switch 132 is turned off, the power storage units 92A and 92B and the power storage units 92C and 92D connected in parallel are divided into the two power storage unit regions R11 and R12.

Next, when the process proceeds to step S6, the control unit 20 executes the third control.

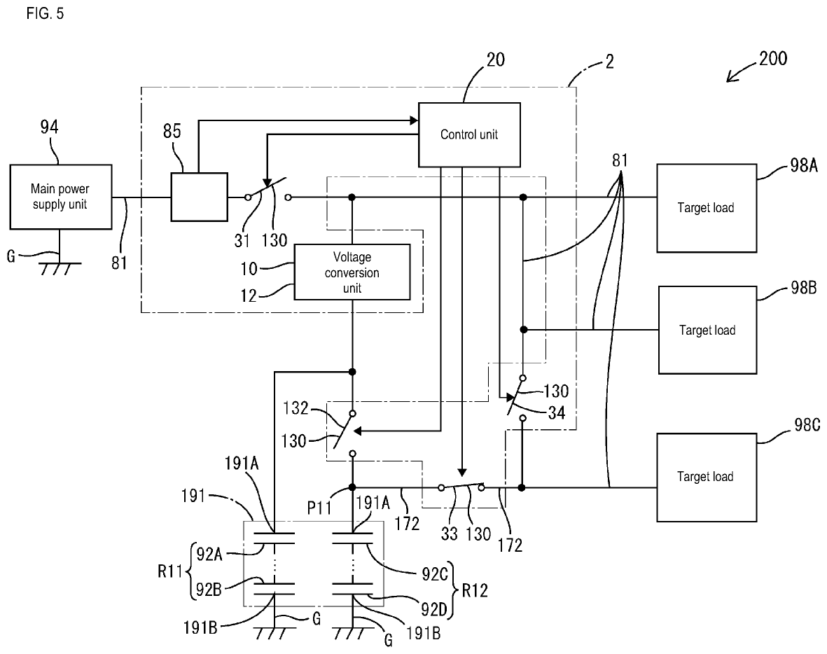

Next, when the process proceeds to step S7, the control unit 20 executes the fourth control. When the third switch 33 is turned on, power supply from the first position P11 to the portion of the first conductive path 81 electrically connected to the target load 98C is enabled. At this time, the switch unit 130 is switched to the second connection state as shown in FIG. 5. In the second connection state, the switch unit 130 divides the plurality of power storage units 92A, 92B, 92C, and 92D connected in parallel into the plurality of power storage unit regions R11 and R12.

Next, when the process proceeds to step S8, the control unit 20 executes the discharge control, and the process shown in FIG. 3 is ended.

In the power supply control device 1, in the first connection state, the switch unit 130 maintains the state in which the power storage units 92A and 92B and the power storage units 92C and 92D are connected in parallel. In the second connection state, the switch unit 130 divides the power storage units 92A and 92B and the power storage units 92C and 92D connected in parallel into the plurality of power storage unit regions R11 and R12. According to this configuration, the power supply control device 2 includes the power storage units 92A and 92B and the power storage units 92C and 92D connected in parallel. This makes it easy to keep the voltage output from the power supply unit 91 at a desired magnitude for a longer period of time, as compared to the case in which the power storage units are connected in series.

### Other Embodiments

The present disclosure is not limited to the embodiments described above and illustrated in the drawings. For example, the following embodiments are also included in the technical scope of the present disclosure.

In the first and second embodiments, the four power storage units 92A, 92B, 92C, and 92D are used as an example. However, the number of power storage units is not limited to four.

In the first embodiment, the second switch 32 divides the power supply unit 91 into the two power storage unit regions R1 and R2 as an example. In the second embodiment, the second switch 132 divides the power supply unit 191 into the two power storage unit regions R11 and R12 as an example. However, the number of second switches may be increased to divide the power storage units into three or more regions. In this case, the number of fourth switches may also be increased and the number of target loads insulated from the main power source may be increased, and bypass conductive paths electrically connecting the target loads and the power storage unit regions may be further provided to assign the power storage unit regions to the target loads.

In the first and second embodiments, the voltage conversion unit 10 also operates as the charging circuit 12 as an example. However, the present disclosure is not limited to this configuration, and the voltage conversion unit and the charging circuit may be separately provided.

In the first and second embodiments, the failure of the main power supply unit 94 is used as a predetermined discharge condition. However, the present disclosure is not limited to this condition. Another condition where power supply from the main power source is not desired may be used as a predetermined discharge condition.

If the power consumption of a power load whose power consumption is undetermined is determined, only the first switch may be turned off while the second switch and the fourth switch are kept on and the third switch is kept off. This makes it possible to supply power from the power supply unit to all of the target loads via the voltage conversion unit. In this case, for example, the control unit may be configured to monitor changes in the power consumption of the power load whose power consumption is undetermined.

In the first and second embodiments, the third control is executed, then the fourth control is executed, and then the discharge control is executed. However, the present disclosure is not limited to this order. The third control may be executed, then the discharge control may be executed, and then the fourth control may be executed.

1. A power supply control device that controls discharge from a power supply unit including a plurality of power storage units, the power supply control device comprising:
a switch unit that switches connection states of the plurality of power storage units; and
a control unit that controls the switch unit,
wherein the switch unit switches between a first connection state in which charging current can be supplied to all of the plurality of power storage units and a second connection state in which the plurality of power storage units are divided into a plurality of power storage unit regions, and
when the switch unit is in the second connection state, power is supplied from the plurality of power storage unit regions to corresponding target loads.

2. The power supply control device according to claim 1, further comprising:
a charging circuit,
wherein the control unit switches the switch unit to the first connection state when the charging current is supplied from the charging circuit to the power supply unit, and switches the switch unit to the second connection state when power is discharged from the power supply unit.

3. The power supply control device according to claim 1, further comprising:
a voltage conversion unit,
wherein, if a predetermined discharge condition is satisfied, the control unit causes the voltage conversion unit to operate with the switch unit switched to the second connection state, and
when the voltage conversion unit operates in the second connection state in response to the satisfaction of the discharge condition, the voltage conversion unit performs voltage conversion based on power from one of the plurality of divided power storage unit regions and supplies the resultant power to one of the target loads, and another power storage unit region and another target load become conductive, without involving the voltage conversion unit, to supply the power to the other target load.

4. The power supply control device according to claim 3,
wherein the switch unit includes:
a first switch that switches a main power supply unit, the power supply unit, and the plurality of target loads between a connected state and a disconnected state;
a second switch that switches the power storage unit regions between the connected state and the disconnected state;
a third switch that switches the other power storage unit region and the other target load between the connected state and the disconnected state; and
a fourth switch that switches the other target load and the main power supply unit between the connected state and the disconnected state,
when switching the switch unit from the first connection state to the second connection state, the control unit executes a first control, a second control, and a third control in this order,
in the first control, the control unit uses the first switch to switch the main power supply unit, the power supply unit, and the plurality of target loads from the connected state to the disconnected state,
in the second control, the control unit uses the second switch to switch the power storage unit regions from the connected state to the disconnected state,
in the third control, the control unit uses the fourth switch to switch the other target load and the main power supply unit from the connected state to the disconnected state, and
the control unit then executes a fourth control to use the third switch to switch the other power storage unit region and the other target load from the disconnected state to the connected state or executes discharge control to discharge power from the voltage conversion unit.

5. The power supply control device according to claim 1, wherein, in the first connection state, the switch unit maintains a state in which the plurality of power storage units are connected in series, and
in the second connection state, the switch unit divides the plurality of power storage units connected in series into the plurality of power storage unit regions.

6. The power supply control device according to claim 1, wherein, in the first connection state, the switch unit maintains a state in which the plurality of power storage units are connected in parallel, and
in the second connection state, the switch unit divides the plurality of power storage units connected in parallel into the plurality of power storage unit regions.
